(19) United States
(12) Patent Application Publication
(10) Pub. No.: US 2026/0032416 A1
(43) Pub. Date: Jan. 29, 2026

(54) SYSTEMS AND METHODS OF IMPLEMENTING A ROAMING MODEL WITHIN TELECOMMUNICATION NETWORKS

(71) Applicant: DISH Wireless L.L.C., Englewood, CO (US)

(72) Inventors: Mehdi Alasti, Arlington, VA (US); Premchand Chandran, Brambleton, VA (US); Siddhartha Chenumolu, Ashburn, VA (US)

(21) Appl. No.: 18/782,458

(22) Filed: Jul. 24, 2024

(51) Int. Cl. H04W 8/08; H04W 36/14; H04W 36/22; H04W 84/04

(52) U.S. Cl. CPC H04W 8/08; H04W 36/14; H04W 36/22; H04W 84/042

(57) ABSTRACT

Systems and methods to dynamically transfer user equipment (UE) within telecommunication networks using a roaming model. One system may include a processing system comprising one or more electronic processors. The processing system may be configured to access first network data for a cell of a home network servicing a set of UE. The processing system may be configured to determine, based on the first network data, whether a first condition of the roaming model is satisfied. The processing system may be configured to, responsive to the first condition being satisfied, facilitate a first transfer of the set of UE from the home network to a partner network, and control a plurality of network resources for the cell of the home network.

### BACKGROUND

This disclosure relates to wireless data networks, such as fifth generation (5G) or sixth generation (6G), wireless networks. Wireless networks that transport digital data and telephone calls are becoming increasingly sophisticated. Currently, 5G broadband cellular networks are being deployed around the world. These 5G networks use emerging technologies to support data and voice communications with millions, if not billions, of mobile phones, computers, and other devices. 5G technologies are capable of supplying much greater bandwidths than previously-available technologies.

The discussion above is merely provided for general background information and is not intended to be used as an aid in determining the scope of the claimed subject matter.

### SUMMARY

Various aspects of the present disclosure relate to systems and methods to implement a roaming model within telecommunication networks to increase network energy efficiency.

According to one aspect of the present disclosure, a system to dynamically transfer user equipment (UE) between telecommunication networks using a roaming model. The system may include a processing system comprising one or more electronic processors. The processing system may be configured to access first network data for a cell of a home network servicing a set of UE. The processing system may be configured to determine, based on the first network data, whether a first condition of the roaming model is satisfied. The processing system may be configured to, responsive to the first condition being satisfied: facilitate a first transfer of the set of UE from the home network to a partner network such that the partner network provides telecommunication services for the set of UE; and control a plurality of network resources for the cell of the home network such that operation of a subset of the plurality of network resources for the cell are deactivated.

According to another aspect of the present disclosure, a method to dynamically transfer user equipment (UE) between telecommunication networks using a roaming model. The method may include accessing, with a processing system including one or more electronic processors, first network data for a cell of a home network providing telecommunication services for a set of UE. The method may include determining, with the processing system, based on the first network data, that a first condition of the roaming model is satisfied. The method may include controlling, with the processing system, a first transfer of the set of UE from the home network to a partner network. The method may include controlling, with the processing system, a plurality of network resources of the cell such that operation of the plurality of network resources of the cell are deactivated. The method may include, responsive to a reactivation of the subset of the plurality of network resources, controlling, with the processing system, a second transfer of the set of UE from the provider network to the home network.

According to another aspect of the present disclosure, a non-transitory computer-readable medium is provided. The non-transitory computer-readable medium stores instructions that, when executed by at least one processor of a computer in a telecommunications network, cause the computer to perform operations comprising: accessing first network data for a cell of a home network providing telecommunication services for a set of UE; determining, based on the first network data, that a first condition of the roaming model is satisfied; controlling a first transfer of the set of UE from the home network to a partner network; controlling a plurality of network resources of the cell such that operation of the plurality of network resources of the cell are deactivated; monitoring the first network data while the set of UE operate on the partner network; determining, based on the first network data, that a second condition of the roaming model is satisfied; controlling the plurality of network resources of the cell such that operation of the plurality of network resources of the cell are activated; and controlling a second transfer of the set of UE from the provider network to the home network.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 schematically illustrates an example of a server in accordance with various aspects of the present disclosure.

FIG. 4 is a flowchart illustrating an example process for using machine learning for traffic load predictions in accordance with some configurations.

FIG. 5 illustrates an example of the telecommunications network of FIG. 1 having multiple provider networks in accordance with various aspects of the present disclosure.

FIG. 6 is a flowchart of an example method to dynamically transfer user equipment (UE) between telecommunication networks using a roaming model in accordance with various aspects of the present disclosure.

FIG. 7 is a diagram illustrating various types of handovers in accordance with various aspects of the present disclosure.

FIG. 8 illustrates an example call flow diagram for a 5G to 5G handover in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like). As another example, the wireless communication networks described herein may comply with other industry standards, such as, e.g., the Distributed Radio Access Network (Distributed RAN or D-RAN) or the like.

D-RAN enables the distribution of radio access functions and the separation of control and user plane functions, which allows for the deployment of RAN functions in various locations, such as, e.g., remote radio heads (RRHs) and baseband units (BBUs). The BBUs may process the control plane functions and the user plane functions and the RRHs may handle radio frequency (RF) processing. Accordingly, D-RAN allows for the deployment of virtualized RAN functions such that RAN functions can be executed as software via a cloud infrastructure.

The O-RAN model follows a virtualized model for a 5G wireless architecture in which 5G base stations, referred to as next-generation Node Bs (gNBs), are implemented using separate centralized units (CUs), distributed units (DUs), and radio units (RUs). In some configurations, O-RAN CUs and DUs may be implemented using software modules executed by distributed (e.g., cloud) computing hardware. Virtualization allows for various other components of the cellular network, such as cellular network core functions, to be implemented as code that is executed using computing resources. Such computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as, e.g., Amazon Web Services (AWS), Azure, Google Cloud, or any private or public cloud(s).

Although spectral efficiency of 5G is better than 4G, higher bit-rates supported by 5G increases the network energy consumption in 5G. To increase energy efficiency, the offered network capacity should fit the traffic. For instance, when a network provider has active UE's fewer than a threshold in a cell (low traffic), the active UE(s) may be transferred to a roaming partner network and the cell (or network resources thereof) pursuant to a roaming mode. According, the technology disclosed herein implements a roaming model to increase network energy efficiency.

Accordingly, the technology disclosed herein provides methods and systems to dynamically transfer user equipment (UE) between telecommunication networks using a roaming model. As described herein, the UE(s) may be dynamically transferred between home networks and partner networks (e.g., roaming networks) responsive to one or more conditions (or an occurrence thereof). A condition may include traffic load conditions, temporal conditions, or a combination thereof. In some configurations, the technology disclosed herein may determine whether one or more conditions are satisfied by monitoring network data.

In some configurations, the technology disclosed herein may determine whether to turn on or off a cell using a roaming model that establishes one or more thresholds for various network-related conditions or parameters. These thresholds can be determined by an artificial intelligence or machine learning engine, a game theoretic models, or a game theoretic model using AI/ML. For example, in some configurations, the technology disclosed herein may implement machine learning to predict future activities, such as, e.g., a number of active UEs, and use the ML model, incorporating predefined thresholds, to control radio activation. The technology disclosed herein may migrate UEs between the home network and the roaming partner network. The technology disclosed herein may use (inter-PLMN) handover of the active UEs and cell reselection of the idle UEs to a roaming partner in the same geographical area when turning the cell off. When the cell is turned on, the UEs may (automatically) move back to the home network.

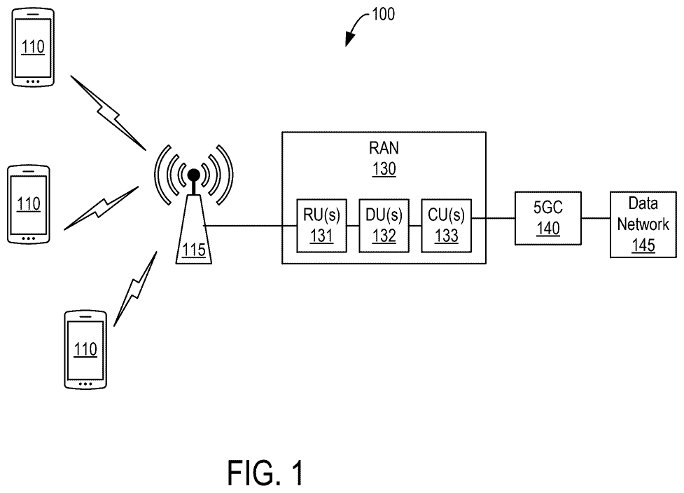

FIG. 1 illustrates an example of a telecommunications network 100 in accordance with various aspects of the present disclosure. In the telecommunications system 100 of FIG. 1, one or more user equipment (UE) 110 may be connected to a wireless access point 115, which in turn may be connected to a radio access network (RAN) 130, including, e.g., one or more radio units (RUs) 131, distributed units (DUs) 132, centralized units (CUs) 133, or a combination thereof. In some configurations, the RAN 130 may be implemented as a virtualized RAN 130. The RAN 130 may provide a connection to a 5G core network (5GC) 140, which in turn may provide a connection to a data network 145. The data network 145 may be the Internet, an enterprise data network, combinations thereof, or the like. The wireless access point 115 and the RAN 130 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network, including, e.g., a telecommunication network capable of being virtualized. For instance, in some implementations, the telecommunication network 100 may be implemented using one or more virtualized RAN components, such as, e.g., one or more virtualized RUs, virtualized DUs, virtualized CUs, or a combination thereof.

As used herein, the term “UE” may be one of various types of end-user devices, such as a cellular phone, a smartphone, a cellular modem, a cellular-enabled computerized device, a sensor device, robotic equipment, a vehicle, an Internet of Things (IoT) device, a gaming device, an access point (AP), or any computerized device capable of communicating via a cellular network (e.g., a cellular network 180). More generally, the UEs 110 can represent any type of device that has an incorporated 5G interface, such as a 5G modem. Examples can include a sensor device, an IoT device, a manufacturing robot, an unmanned aerial (or land-based) vehicle, a network-connected vehicle, etc. Depending on the location of individual UEs 110, the UEs 110 may use radio frequency (RF) to communicate with various base stations of a telecommunications network (e.g., the wireless access point 115 of the telecommunications network 100 of FIG. 1). While FIG. 1 illustrates three UEs 110 connected to the wireless access point 115, in practical implementations any number of UEs 110 may be connected to the wireless access point 115 at any given time.

The wireless access point 115 may represent the physical infrastructure (e.g., a 5G tower or base station) to which the UE(s) 110 connect. The wireless access point 115 may be any structure to which one or more antennas are mounted. The wireless access point 115 may be a dedicated cellular tower, a building, a water tower, or any other man-made or natural structure to which one or more antennas can reasonably be mounted to provide cellular coverage to a geographic area.

The wireless access point 115 may include the RU(s) 131 configured to convert radio signals sent to and received from the antenna(s) into a digital signal. The wireless access point 115 is connected to the RAN components 130 via a fronthaul link over which the digital signals may be communicated. The DU(s) 132 may be connected to the CU(s) 133 via a mid haul link. The CU(s) 133 may be connected to the 5GC 135 via a backhaul link. While FIG. 1 illustrates a single wireless access point 115, in practical implementations the telecommunications network 100 may include any number of wireless access points 115.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center or group of data centers that allows for redundancy, thereby to provide fail-over protection from other availability zones within the same cloud computing region. For example, when a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU 132 and a number of RUs 131 (e.g., six RUs 131) assigned to it.

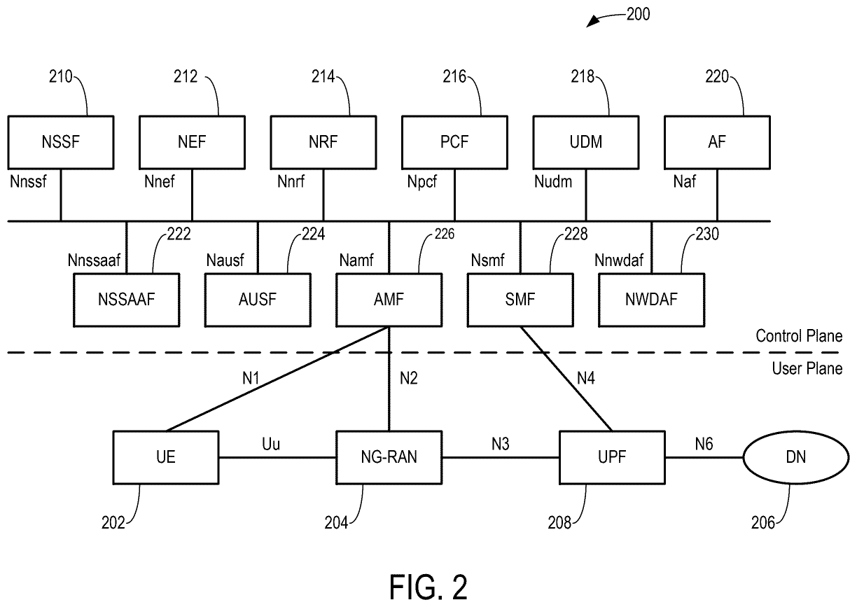

The 5GC 140 provides a plurality of 5G core functions. In the topology of a 5G NR cellular network, 5G core functions of 5GC 140 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within a regional data center (RDC) are described in more detail with regard to FIG. 2. The data network 145 may be the Internet, an enterprise data network, combinations thereof, or the like.

FIG. 2 illustrates an example architecture 200 for a telecommunications network (e.g., the telecommunications network 100 of FIG. 1) in accordance with various aspects of the present disclosure. In some instances, the architecture 200 may be a service-based architecture (SBA), such as, e.g., a SBA based on HTTP2. The architecture 200 may be divided between a control plane (CP) and a user plane (UP). The CP may include a plurality of CP network functions (NFs). The UP may include a UE 202 (e.g., one of the UEs 110 of FIG. 1) connected to an NG-RAN 204, and UP NFs (e.g., a User Plane Function (UPF) 208). In some implementations, using the architecture 200, the UE 202 may access a data network 206 (e.g., the data network 140 of FIG. 1). For case of illustration, FIG. 2 only shows a single UE 202 being connected to the NG-RAN 204; however, in practical implementations, any number of UEs 202 may be present, limited only by the capacity of the network. Any of the NFs illustrated in FIG. 2 and/or described herein may be implemented as a software unit residing on a server (i.e., in the cloud).

The UP NFs may include a User Plane Function (UPF) 208. The UPF 208 is a NF that routes and forwards UP data packets between the base station (cell site; for example, the NG-RAN 204) and the data network 206 (e.g., the Internet). The UPF 208 may be similar to the service and packet gateway functions in a 4G network, but the UPF 208 is cloud-native and can be deployed anywhere to meet service requirements. The UPF 208 can also manage, prioritize, and duplicate data packets as those data packets traverse the network, thus offering redundancy and quality-of-service (QoS) assurance.

The CP NFs may include a Network Slice Selection Function (NSSF) 210, a Network Exposure Function (NEF) 212, a Network Repository Function (NRF) 214, a Policy Control Function (PCF) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Network Data Analytics Function (NWDAF) 230.

The NSSF 210 may be a CP function that provides network slices to the AMF 226. A network slice is an independent, end-to-end logical network that runs on shared physical network infrastructure. The network slice involves the allocation of network resources across all network infrastructure to meet specific service requirements, from the network core to the RAN. Specific requirements may include QoS assurance, security policies, data isolation, dynamic policy management, etc.

The NEF 212 may be a CP function that provides information regarding the NFs that are available to use (by the enterprise customer). The NEF 212 may be similar to the 4G Service Capabilities Exposure Function (SCEF), but the NEF 212 is cloud-native and exposes event information, network monitoring, network control, provisioning capabilities, and policy/charging capabilities externally. This allows the enterprise customer to monitor and affect QoS and charging for devices.

The NRF 214 may be a CP function that allows 5G NFs to be registered, discovered, and subsequently made available to customers. This is a unique capability in the SA 5G network that allows customers to subscribe to the necessary microservices or to have dedicated NFs for their services.

The PCF 216 may be a CP function that provides policies for mobility and session management. The PCF 216 may be similar to the Policy and Charging Rules Function (PCRF) in a 4G network, but the PCF 216 is cloud-native and offers additional capabilities in the 5G network, including event-based policy triggers, resource reservation requests, and access network discovery and selection. The PCF 216 may directly influence QoS and subscriber spending limits, and, as a result, may play a role in the enhanced policy management and control capabilities of the 5G network.

The UDM 218 may be a CP function that manages and stores subscriber and device information, default QoS and prioritization, authorized data channels, maximum bit rates, service continuity provisions, and the like. The UDM 218 may be similar to the Home Subscriber Server (HSS) function in a 5G network, but the UDM 218 is cloud-native and designed for 5G services.

The AF 220 may be a CP function that interacts with the 3GPP Core Network in order to provide services, for example, to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 may be a CP function that supports authentication and authorization of slicing with an AAA server (Authentication, Authorization, and Accounting). The NSSAAF 222 may be a unique capability of the SA 5G network that allows customers to access a predefined network slice or a newly requested network slice in real-time (or near real-time) and using their own existing authentication infrastructure.

The AUSF 224 may be a CP function that supports authentication for 3GPP access and untrusted non-3GPP access, and authentication of a UE for a disaster roaming service. The AUSF 224 can act as an authentication server.

The AMF 226 may be a CP function that manages registration, authorization, connection, reachability, and mobility. The AMF 226 may be similar to the Mobility Management Entity (MME) function in a 4G network, but the AMF 226 is cloud-native and supports many additional capabilities unique to 5G. For example, the AMF 226 may also support dynamic updating of network interfaces and cellular sites, greater privacy via the use of a 5G temporary device identity, enhanced security across the user and control planes, and storing of network slice information. The AMF 226 can also select an appropriate PCF for a device or use case.

The SMF 228 may be a CP function that oversees packet data session management, IP address allocation, data tunneling from a cell site base station to the UP function, and downlink notification management. The SMF 228 may perform the tasks of the serving and packet gateways (S-GW & P-GW) in a 4G network, but also allows for CP and UP separation in 5G.

The NWDAF 230 may be a CP function that collects data from pertinent network infrastructure relevant to a customer's services, including UE (device), NFs, network operations and administration, cloud, and edge that can be used for data analytics and insights. The NWDAF 230 may be a unique SA 5G NF that exposes full visibility to network performance and operations as they relate to a customer's key performance indicators (KPIs).

The SBA 200 may further include a plurality of service-based interfaces to provide access to or communication with the various NFs. As illustrated, such service-based interfaces may include an Nnssf interface for the NSSF 210, an Nnef interface for the NEF 212, an Nnrf interface for the NRF 214, an Npcf interface for the PCF 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, and an Nnwdaf interface for the NWDAF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a 5G-Equipment Identity Register (5G-EIR), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), or a Trusted WLAN Interworking Function (TWIF).

For purposes of explanation, the technology disclosed herein will be described as being implemented in a 5G O-RAN network; however, in practice technology disclosed herein may be implemented with any RAN architecture (including, e.g., any virtualized RAN architecture). Moreover, for purposes of explanation, the systems and methods described herein will be described as being implemented in a network operating using AWS; however, these are merely examples and not limiting. The systems and methods of the present disclosure may be implemented with other web services provider and with other container organization architectures. The methods described herein may be performed by a processing system including at least one electronic processor, where the at least one electronic processor may be or include a processor as described herein (e.g., including one or more individual electronic processors). A data center server is an example of such a processing system that may perform the methods described herein.

As described herein with respect to FIG. 1, the 5GC 140 provides a plurality of 5G core functions, which may reside and/or execute via one or more data centers (e.g., one or more NDCs or RDCs), including, e.g., one or more data center servers. For instance, in some configurations, the data center server(s) may store and execute a set of instructions for executing one or more NF as described herein. Additionally, in some embodiments, the data center server may be a local server located at corresponding cell site(s) (e.g., as part of an on-site computing platform of a corresponding wireless access point 115 or cell site). Alternatively, or in addition, in some embodiments, the data center server may be a remote cloud server located remotely from corresponding cell site(s).

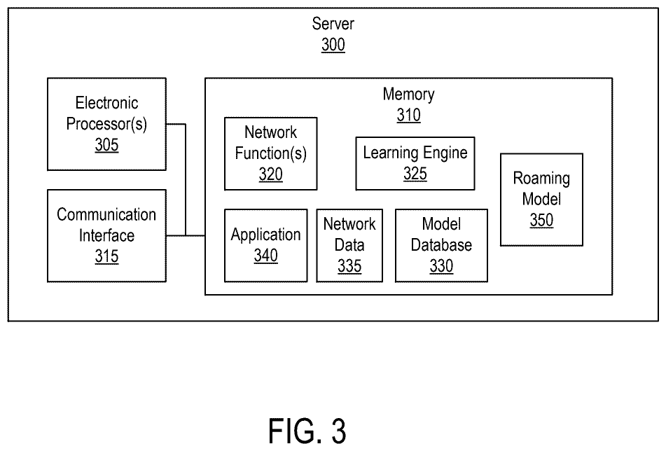

For example, FIG. 3 schematically illustrates an example server 300 (e.g., a data center server for the 5GC 140 of FIG. 1) according to some configurations. As illustrated in FIG. 3, the server 300 includes an electronic processor 305, a memory 310, and a communication interface 315. The electronic processor 305, the memory 310, and the communication interface 315 may communicate wirelessly, over one or more communication lines or buses, or a combination thereof. The server 300 may include additional, different, or fewer components than those illustrated in FIG. 3 in various configurations. The server 300 may perform additional or different functionality than the functionality described herein. Also, the functionality (or a portion thereof) described herein as being performed by the server 300 may be performed by another component (e.g., another data center server or component of the 5GC 140), distributed among multiple devices (e.g., as part of a cloud service or cloud-computing environment), combined with another component (e.g., another component of the telecommunications network 100), or a combination thereof.

The communication interface 315 may include a transceiver that communicates with other components of the telecommunications network 100, such as, e.g., the data network 145, the RAN 130, including, e.g., the RU(s) 131, DU(s) 132, or CU(s) 133, etc. over one or more communication networks or connections. The electronic processor 305 includes one or more processors (e.g., one or more microprocessors, one or more application-specific integrated circuits (ASICs), and/or one or more other suitable electronic device for processing data), and the memory 310 includes a non-transitory, computer-readable storage medium. The electronic processor 305 is configured to retrieve instructions and data from the memory 310 and execute the instructions.

For example, as illustrated in FIG. 3, the memory 310 may store one or more network functions 320. The network functions 320 may include, e.g., one or more of the network functions described herein, such as, e.g., with respect to FIG. 2.

As also illustrated in FIG. 3, the memory 310 may also include a learning engine 325 and a model database 330. In some configurations, the learning engine 325 develops one or more models using one or more machine learning functions. Machine learning functions are generally functions that allow a computer application to learn without being explicitly programmed. In particular, the learning engine 325 is configured to develop an algorithm or model based on training data. As one example, to perform supervised learning, the training data includes example inputs and corresponding desired (for example, actual) outputs, and the learning engine 325 progressively develops a model that maps inputs to the outputs included in the training data. As another example, to perform self-supervised learning (“SSL”), a model is trained on a task using the data itself to generate supervisory signals (e.g., unlabeled training data), rather than relying on, e.g., external labels provided by a user (e.g., labeled training data). As yet another example, to perform semi-supervised learning, the training data may include desired output values for a subset of the training data (e.g., labeled training data) while the remaining training data may be unlabeled or imprecisely labeled (e.g., unlabeled training data). Machine learning performed by the learning engine 325 may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. These approaches allow the learning engine 325 to ingest, parse, and understand data and progressively refine models.

As one example, the learning engine 325 may develop a traffic load prediction model. The traffic load prediction model may be an artificial intelligence or machine learning model trained to predict traffic load for one or more cells of the telecommunications network 100. As described herein, in some instances, the technology disclosed herein may utilize traffic load predictions in order to. For example, in some configurations, the technology disclosed herein may determine whether one or more conditions are satisfied based on traffic load prediction(s).

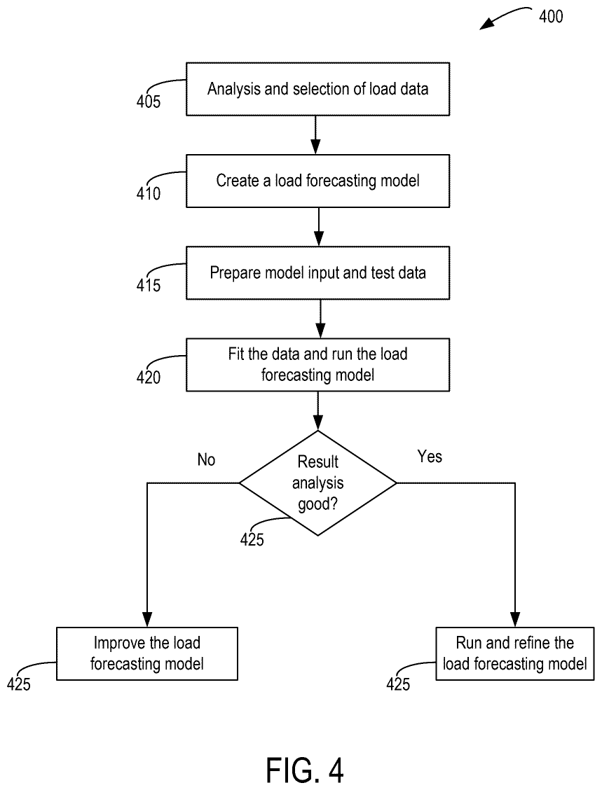

For example, FIG. 4 is a flowchart illustrating an example process 400 for using machine learning for load predictions in accordance with some configurations. The process 400 of FIG. 4 may be implemented by the server 300, and, in some instances, by the learning engine 325. At step 405, the process 400 may include collecting historical load data, such as, e.g., for one or more particular cell sites within the telecommunications network 100. The historical load data may be included as part of the network data 335. Accordingly, in some instances, the network data 335 (or portion(s) thereof) may be used as training data for one or more models described herein. At step 410, the process 400 may include analyzing and selecting traffic load data, such as, e.g., a portion of the network data 335 specific to a particular cell site of the telecommunications network 100. At step 415, the process 400 may include creating (e.g., via the learning engine 325) a load forecasting model (also referred to herein as a traffic load prediction model). The traffic load prediction model may be created using the traffic load data of step 410. At step 420, the process 400 may include preparing model input and test data. At step 425, the process 400 may include fitting the data and running the traffic load prediction model. After fitting the data and running the traffic load prediction model, the process 400 may determine whether a result analysis is good (at step 430). When the result analysis is good, the process 400 may run and refine the traffic load prediction model (at step 435). When the result analysis is not good, the process 400 may improve the traffic load prediction model (at step 440).

Models generated by the learning engine 325 can be stored in the model database 330. As illustrated in FIG. 3, the model database 330 may be included in the memory 310. It should be understood, however, that, in some configurations, the model database 330 may be included in one or more separate devices accessible by the server 300 of FIG. 3 (including a remote database, and the like).

As also illustrated in FIG. 3, the memory 310 may also include network data 335. The network data 335 may include information or data relating to the telecommunication network 100, including one or more cell sites thereof. In some examples, the network data 335 may include one or more performance metrics, including, but are not limited to, packet loss information, data throughput information, network latency information, and/or other metrics information that may quantify the performance of the telecommunications network 100. Network latency information is a measure of the round-trip time from for data packets to travel from a cell to any UE that is in wireless communication with the telecommunications network 100. Data throughput information is a measure of the data transfer rate between the cell and the UE. Packet loss information is a measure of the reliability of data transmission between the cell and the UE. Accordingly, in some configurations, the network data 335 may include load-related information or data for the telecommunications network 100.

Alternatively, or in addition, in some configurations, the network data 335 may include UE-related data, such as, e.g., a UE count per UE status (e.g., a number of idle UEs for a cell site, a number of active UEs for a cell site, a number of inactive UEs for a cell site, etc.), UE identification information, etc. Alternatively, or in addition, in some configurations, the network data 335 may include cost-related information or data, such as, e.g., operating costs for one or more cells within the telecommunications network 100 (e.g., a cost associated with operating a specific cell), roaming costs (e.g., a cost associated with one or more UEs roaming with respect to a partner network), etc. Alternatively, or in addition, in some configurations, the network data 335 may include time-related information or data, such as, e.g., a certain time period (e.g., weekday commute, weekday lunch hour, weekend night, or week), expected or predicted network usage for a specific time period, etc.

As illustrated in FIG. 3, the memory 310 may store an application 340. The application 340 is a software application executable by the electronic processor 305. As described in more detail herein, the electronic processor 305 may execute the application 340 to control the dynamic transferring of UEs 110 between providers within telecommunication networks (e.g., the telecommunication network 100 of FIG. 1), as described in greater detail herein.

In some configurations, the memory 310 may store a roaming model 350. The roaming model 350 may include a set of conditions that, when satisfied, trigger one or more network actions, as described in greater detail herein. The network actions may include, e.g., a shutdown event, an activation event, etc. A shutdown event may include transferring one or more UEs 110 from a home network to a partner network, reducing (or otherwise shutting down) one or more network resources or components of the telecommunication network 100 (or cell site(s) thereof), or a combination thereof. An activation event may include activating (or otherwise turning on) one or more network resources or components of the telecommunication network 100 (or cell site(s) thereof), such as, e.g., the one or more network resources or components shutdown as part of a shutdown event, transferring one or more UEs 110 roaming on a partner network back to a home network, or a combination thereof. The roaming model 350 may provide a mapping (or association) between various combinations of conditions and resulting network actions, as described in greater detail herein. For example, the roaming model 350 may map a set of conditions (also referred to herein as shutdown condition(s)) to the shutdown event, a set of conditions (also referred to herein as activation condition(s)) to the activation event, etc.

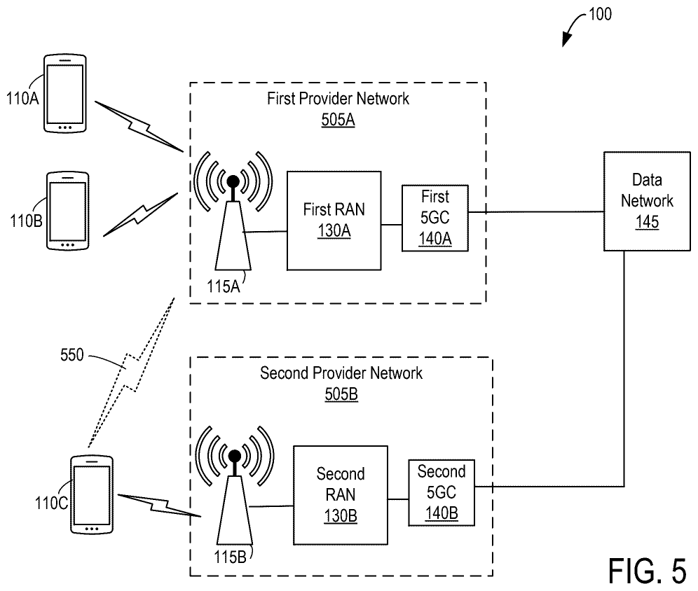

FIG. 5 illustrates an example of the telecommunications network 100 of FIG. 1 having multiple provider networks in accordance with various aspects of the present disclosure. As used herein, a provider network may include one or more components of the telecommunications network 100 that are managed or maintained by a particular telecommunications provider or carrier, where that particular telecommunications provider or carrier provides telecommunication services to one or more customers or end users of the UE(s) 110 under contract or other service agreement with the telecommunications provider or carrier.

In the example illustrated in FIG. 5, the telecommunications network 100 includes a first provider network 505A and a second provider network 505B. The first provider network 505A may include a first wireless access point 115A (e.g., the wireless access point 115 of FIG. 1), a first RAN 130A (e.g., the RAN 130 of FIG. 1), and a first 5GC 140A (e.g., the 5GC 140 of FIG. 1). The second provider network 505B may include a second wireless access point 115B (e.g., the wireless access point 115 of FIG. 1), a second RAN 130B (e.g., the RAN 130 of FIG. 1), and a second 5GC 140B (e.g., the 5GC 140 of FIG. 1). As noted herein, with respect to the RAN 130 of FIG. 1, in some instances, one or more components of the RAN 130 may be virtualized. Similarly, in some instances, the first RAN 130A (or component(s) thereof), the second RAN 130B (or component(s) thereof), or a combination thereof, may be virtualized (e.g., as a first virtualized RAN 130A, a second virtualized RAN 130B, etc.). As illustrated, the first provider network 505A may provide telecommunication services to a first UE 110A and a second UE 100B (e.g., via enabling the first UE 110A and the second UE 100B to interact with (or otherwise connect with) the data network 145). The first provider network 505A may be considered a “home network” and the second provider network 505B may be considered a “partner network” for the first UE 110A and the second UE 110B. Similarly, the second provider network 505B may provide telecommunication services to a third UE 110C (e.g., via enabling the UE 110C to interact with (or otherwise connect with) the data network 145). The second provider network 505B may be considered a “home network” and the first provider network 505A may be considered a “partner network” for the third UE 110C.

In some instances, a telecommunication provider or carrier may allow a non-contracted customer or end user to utilize network resources (e.g., telecommunication services) provided by the telecommunication provider or carrier (also referred to as “roaming”). For example, with reference to the example of FIG. 5, the first provider network 505A may provide telecommunication services to the third UE 110C (such as, e.g., when the second provider network 505B is inactive or down or the third UE 110C is out of range of the second wireless access point 115B) (represented in FIG. 5 by reference numeral 550). The third UE 110C may be considered “roaming” with respect to the first provider network 505A.

While the example of FIG. 5 illustrates two provide networks, the telecommunications network 100 may include any number of provider networks. Additionally, while the example of FIG. 5 illustrates each provider network as including a corresponding wireless access point 115, a corresponding RAN 130 (e.g., a corresponding virtualized RAN 130), and a corresponding 5GC 140, the provider networks may include additional, fewer, or different components than illustrated in FIG. 5 in various configurations. Further, while the example of FIG. 5 illustrates two UEs (e.g., the first UE 110A and the second UE 110B) being associated with the first provider network 505A and a single UE (e.g., the third UE 110C) being associated with the second provider network 505B, any number of UEs may be associated with any number of provider networks.

FIG. 4 illustrates a flowchart of an example method 400 to control dynamic transfers of UEs within telecommunication networks (e.g., the telecommunication network 100) according to some configurations. The method 400 is described as being performed by the server 300 and, in particular, the electronic processor 305. However, as noted above, the functionality (or a portion thereof) described with respect to the method 400 may be performed by other devices, such as, e.g., another server or device within the telecommunication network 100, or distributed among a plurality of devices, such as a plurality of servers included in a cloud service. Thus, although described as begin performed by the server 300, the method 400 may also be described as being performed by a processing system including one or more electronic processors (e.g., another processor or processors of the telecommunication network 100).

As illustrated in FIG. 4, the server 300 may access (or otherwise retrieve) network data (e.g., the network data 335) for a cell of a home network (at block 605). In some configurations, one or more components of the telecommunications network 100 may provide the network data 335 to the server 300. Alternatively, or in addition, the server 300 may request or otherwise retrieve the network data 335 from one or more components of the telecommunications network 100. The server 300 may access the network data 335 from the memory 305.

Alternatively, or in addition, the server 300 may access the network data 335 from a remote device (e.g., one or more components of the telecommunications network 100 that the network data 335 originates from, another remote database or storage device, etc.).

In some examples, in some configurations, each DU (e.g., the DU 132 of FIG. 1) of the telecommunications network 100 (e.g., each DU for each cell site of the telecommunications network 100) may execute a traffic load analysis (e.g., a machine learning based traffic load analysis) continuously (e.g., in real time or near real-time), intermittently or periodically (e.g., hourly, daily, etc.), etc. The DU 132 may calculate an average traffic load value based on the traffic load analysis. In such instances, the DU 132 may provide the results of the traffic load analysis, including, e.g., the average traffic load value, for the corresponding cell site to the server 300. Alternatively, or in addition, in some configurations, the DU 132 may execute a regression machine learning engine or model to predict a future load of the corresponding cell site, where the future load of the corresponding cell site may be included in the network data 335. In some configurations, the server 300 may execute such a regression machine learning engine or model (e.g., via the learning engine 325, the model database 330, etc.).

Alternatively, or in addition, in some instances, each CU (e.g., the CU 133 of FIG. 1) of the telecommunications network 100 (e.g., each CU for each cell site of the telecommunications network 100) may execute a traffic load analysis (e.g., a machine learning based traffic load analysis) continuously (e.g., in real time or near real-time), intermittently or periodically (e.g., hourly, daily, etc.), etc. The CU 133 may calculate an average traffic load value based on the traffic load analysis. In such instances, the CU 133 may provide the results of the traffic load analysis, including, e.g., the average traffic load value, for the corresponding cell site to the server 300. Alternatively, or in addition, in some configurations, the CU 133 may execute a regression machine learning engine or model to predict a future load of the corresponding cell site, where the future load of the corresponding cell site may be included in the network data 335. In some configurations, the server 300 may execute such a regression machine learning engine or model (e.g., via the learning engine 325, the model database 330, etc.).

Accordingly, in some configurations, the CU 133 may perform a traffic load analysis and may make a decision for a set of cells. For instance, the CU 133 may identify (or otherwise determine) a set of cells covering a contiguous geographical area and determine to push (or transfer) one or more UEs in each cell of the set of cells to roam on a partner network and turn off the set of cells.

The server 300 may determine whether a shutdown condition of the roaming model 350 is satisfied (at block 610). In some instances, the shutdown condition may also be referred to herein as a first condition. The shutdown condition may include one or more conditions that, when satisfied, trigger a transfer event, a shutdown event, or a combination thereof. A transfer event may include a dynamic transfer of one or more UEs 110 (also referred to herein as a set of UEs 110) from a home network to a partner network. For example, with reference to FIG. 4, a transfer event may include the transfer of the third UE 110C from the second provider network 505B (as a home network for the third UE 110C) to the first provider network 505A (as a partner network for the third UE 110C) (represented in FIG. 4 by reference numeral 550). A shutdown event may include a reduction in network resources at one or more cell sites of a provider network. For example, a shutdown event may include a complete shutdown of a cell site (e.g., ceasing operation of all network resources for a cell site). Alternatively, a shutdown event may include a partial shutdown of a cell site (e.g., ceasing or reducing operation of a subset of the network resources for a cell site). As one example, with reference to FIG. 4, the shutdown event may include ceasing operation of the second wireless access point 115B, the second RAN 130B, the second 5GC 140B, other component(s) included in the second provider network 505B, or a combination thereof.

In some configurations, the shutdown condition may include (or otherwise define) a parameter and a threshold value for that parameter such that when a value of the parameter satisfies the threshold value (e.g., is greater than, less then, equal to, etc.) the shutdown condition is satisfied. In some configurations, the shutdown condition may include multiple parameters and corresponding thresholds. Alternatively, or in addition, in some configurations, the shutdown condition may be cell site dependent such that different cell sites of the telecommunications network 100 may be associated with different conditions. For example, a first shutdown condition for a first cell site may be different than a second shutdown condition for a second cell site.

As one example, in some configurations, the shutdown condition may be a traffic load condition. A traffic load condition may include a network parameter that is related to traffic load (e.g., indicates a traffic load of a cell site). For example, the shutdown condition may include a number of active UEs 110 of a cell site (e.g., a number of the UEs 110 actively using a particular cell site) and a threshold number of active UEs 110 of a cell site. Following this example, when the number of active UEs 110 of a cell site is below (e.g., is greater than or is great than or equal to) a threshold number of active UEs 110, the shutdown condition may be satisfied.

Alternatively, or in addition, in some configurations, the shutdown condition may be a temporal condition. A temporal condition may define a specific time schedule. For instance, the temporal condition may include, e.g., a time, a time range, a day of the week, a holiday, etc.). The temporal condition may be satisfied when a present (or temporally current) time or day condition matches the temporal condition. As one example, when the temporal condition includes a time range of 12:00 AM-2:00 AM and the present time is within the time range (e.g., is 1:00 AM), the temporal condition may be satisfied. As another example, the temporal condition may include a time range of 12:00 AM-2:00 AM and a day of the week of Monday. Following this example, the temporal condition may be satisfied when a present time is 1:00 AM and a present day of the week is Monday.

As noted herein, in some configurations, the shutdown condition may include multiple parameters and corresponding thresholds (e.g., multiple conditions). For instance, in some configurations, the shutdown condition may include a temporal condition and a traffic load condition. In such configurations, the shutdown condition may be satisfied when either the temporal condition or the traffic load condition is met. Alternatively, or in addition, in some configurations the shutdown condition may be satisfied when both the temporal condition and the traffic load condition is met.

The server 300 may determine whether the shutdown condition of the roaming model 350 is satisfied based on the network data 335 (e.g., as accessed at block 605). For instance, the server 300 may identify the relevant portion(s) of the network data 335 and compare those relevant portion(s) to a corresponding threshold (or thresholds) to determine whether the shutdown condition is satisfied.

For example, in some configurations, the shutdown condition may be a traffic load condition. In such instances, the server 300 may determine a current traffic load for a cell site of the telecommunications network 100. The server 300 may compare the current traffic load for the cell site to a corresponding traffic load threshold. The corresponding traffic load threshold may indicate a threshold traffic load that suggests an energy savings (and cost savings) may be achieved by transferring UEs 110 to a partner network and shutting down the corresponding cell site (or a portion thereof). In some configurations, all UEs 110 (including active UEs and idle UEs) within a cell may be moved to a partner network. In such configurations, active UEs may be transferred using a first process while idle UEs may be transferred using a different process. As one example, active UE(s) may be transferred to the partner network using a handover process (as described herein) and idle UE(s) may be transferred to the partner network using a cell-reselection process. Accordingly, when the traffic load threshold is satisfied, the cell site may be experiencing a low traffic demand, and, when the traffic load threshold is not satisfied, the cell site may be experiencing a high traffic demand. When the current traffic load for the cell site is below the corresponding traffic load threshold, the server 300 may determine that the shutdown condition is satisfied (e.g., Yes at block 610). When the current traffic load for the cell site is above (or equal to) the corresponding traffic load threshold, the server 300 may determine that the shutdown condition is not satisfied (e.g., No at block 610).

Alternatively, or in addition, in some configurations, the shutdown condition may include a traffic load condition, a temporal condition, or a combination thereof. In such configurations, the server 300 may determine whether the shutdown condition is satisfied based on traffic load history information, e.g., as included in the network data 335, (as the traffic load condition), based on a specific time schedule (as the temporal condition), or a combination thereof. For example, the server 300 may determine whether the shutdown condition is satisfied based on traffic load data (or statistics) at or during a scheduled time or day. When the traffic load data for the scheduled time or day satisfy the traffic load threshold (e.g., is below the traffic load threshold), the server 300 may determine that the shutdown condition is satisfied (e.g., Yes at block 610). When the traffic load data for the scheduled time or day satisfy the traffic load threshold (e.g., is greater than (or equal to) the traffic load threshold), the server 300 may determine that the shutdown condition is not satisfied (e.g., No at block 610).

In some configurations, when the shutdown condition of the roaming model 350 is not satisfied (e.g., No at block 610), the method 600 may return to block 610. For instance, when the first condition of the roaming model is not satisfied, the server 300 may continuously or intermittently access (or otherwise retrieve) the network data 335. Alternatively, or in addition, the server 300 may access (or otherwise retrieve) the network data 335 responsive to availability or receipt of additional (or new) network data 335. For instance, responsive to receiving additional network data from one or more components of the telecommunications network 100, the server 300 may access the network data 335, including, e.g., the additional network data (e.g., as described herein with respect to block 605). The server 300 may then again determine whether the first condition of the roaming model is satisfied based on the network data 335, which now includes the additional network data (e.g., as described herein with respect to block 610).

In some configurations, when the shutdown condition of the roaming model 350 is satisfied (e.g., Yes at block 610), the method 600 may move to block 615. At block 615, the server 300 may facilitate a transfer of one or more UEs 110 of the corresponding cell site. In some configurations, the server 300 may facilitate the first transfer such that the UE(s) 110 of the corresponding cell site are transferred from a home network to a partner network, such that the partner network provides telecommunication services for the UEs 110 (as roaming UEs 110 on the partner network. For instance, with reference to the example of FIG. 4, the first transfer may include transferring the third UE 110C from the second provider network 505B (as the home network for the third UE 110C) to the first provider network 505A (as the partner network for the third UE 110C).

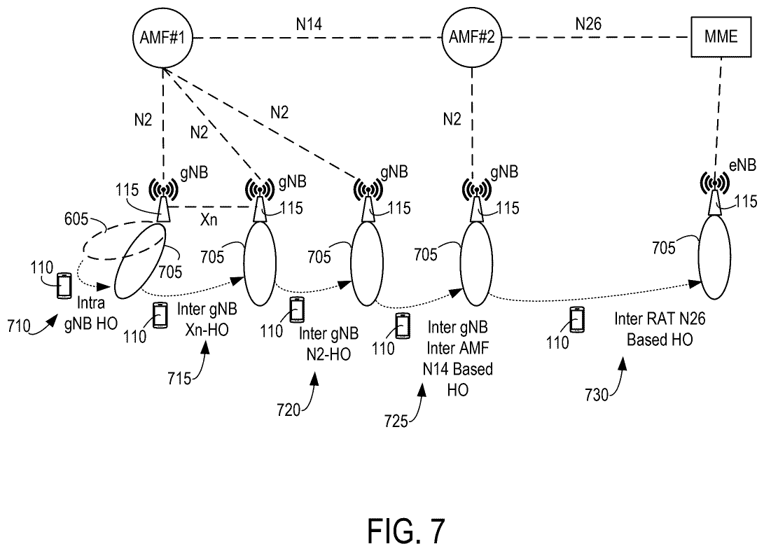

In some configurations, the server 300 may facilitate the transfer of the UEs 110 by controlling (or otherwise implementing) a handover (HO). FIG. 7 is a diagram illustrating various types of HOs between cells (represented in FIG. 7 by reference numeral 705) within telecommunication networks (e.g., the telecommunications network 100 of FIG. 1) according to some configurations. For instance, as illustrated in FIG. 7, the HOs may include, e.g., an intra gNB HO 710, an inter gNB Xn-HO 715, an Inter gNB N2-HO 720, an inter gNB Inter AMF N14 based HO 725, and an inter RAT N26 based HO 730. The HOs included in FIG. 7 are examples, and, the technology disclosed herein may be implemented including additional, different, or fewer HOs than illustrated in the example of FIG. 7.

In some examples, the server 300 may facilitate the transfer of the UE(s) 110 using an inter-provider land mobile network (inter-PLMN). In such examples, the UE(s) 110 may remain in a connected mode through the inter-PLMN handover. For instance, the home network of the UE(s) 110 (e.g., a source gNB of the home network) (e.g., the server 300) may contact a partner network (e.g., a target gNB of the partner network) to request a HO. Responsive to a positive response to the request, the server 300 may transfer the RAN context information of the UE(s) 110 from the home network (e.g., the source gNB) to the partner network (e.g., the target gNB). The server 300 may then instruct the UE(s) 110 to detach from the home network and attach to the partner network.

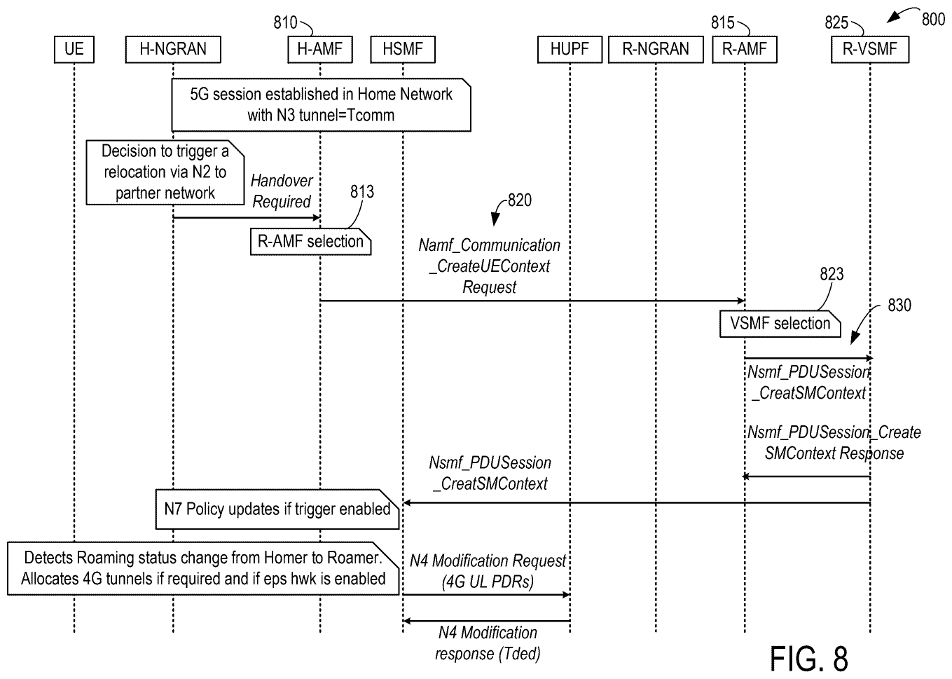

FIG. 8 illustrates an example call flow diagram 800 for a 5G to 5G HO, and, in particular, an inter-PLMN mobility involving a 5G (home) to 5G (roaming) UE mobility. For example, as illustrated in FIG. 8, when a UE 110 moves to the roaming partner network from the home network, the H-AMF 810 (in the home network) selects (represented in FIG. 8 by reference number 813) an R-AMF 815 (in the partner network) based on serving network, slice, etc. and sends a Namf_Communication_CreateUEContext Request message (represented in FIG. 8 by reference numeral 820) to the R-AMF 815. The R-AMF 815 then selects (represented in FIG. 8 by reference numeral 823) an R-VSMF 825 in partner network based on the serving PLMN, serving Tracking Area Identity (TAI), Data Network Name (DNN), etc. Further, the R-AMF 815 detects that the handover is an inter-PLMN visiting handover and initiates an N11 Create Request (represented in FIG. 8 by reference numeral 830) rather than an N11 Update Request to the partner R-VSMF 825. Thereafter, the partner R-VSMF 825 treats the N11 Create Request 830 similar to an inter-RAT 4G to 5G intra-PLMN handover.

Alternatively, or in addition, in some configurations, the server 300 may facilitate the transfer of the UE(s) 110 using an inter-PLMN multi-access PDU session (e.g., using an access traffic steering, switching, and splitting (ATSSS) function). For instance, using the inter-PLMN MA-PDU session, the UE(s) 110 may be connected through two PDU sessions to the UPF (ATSSS). The first PDU session may be through the home network (e.g., a home-PLMN). The second PDU session may be home routed through a (roaming) partner network (e.g., a visited-PLMN or a partner-PLMN). The ATSSS may define the first PDU session (through the home-PLMN) as a high priority and the second PDU session (through the visited-PLMN) as the low priority. While the cell site of the home-PLMN is ON (e.g., active), traffic associated with the UE(s) 110 may be routed through the first PDU session on the home-PLMN. When the cell site of the home-PLMN is turned OFF (e.g., shutdown), traffic associated with the UE(s) 110 may (automatically) be routed through the second PDU session on the visited-PLMN.

Alternatively, or in addition, in some configurations, the server 300 may facilitate the transfer of the UE(s) 110 using a conditional handover. As one example, the server 300 may facilitate the transfer of the UE(s) 110 using an intra-PLMN conditional handover, such as, e.g., as a 3GPP conditional handover within a 5G wireless network. As another example, the server 300 may facilitate the transfer of the UE(s) 110 using an inter-PLMN conditional handover, such as, e.g., as a 3GPP conditional handover within a 6G wireless network. For instance, in some configurations, based on one or more artificial intelligence or machine learning models (e.g., the models stored in the model database 330), the server 300 may determine, for each cell in a certain geographical area, optimal times to shutdown or activate a cell site (or component(s) thereof).

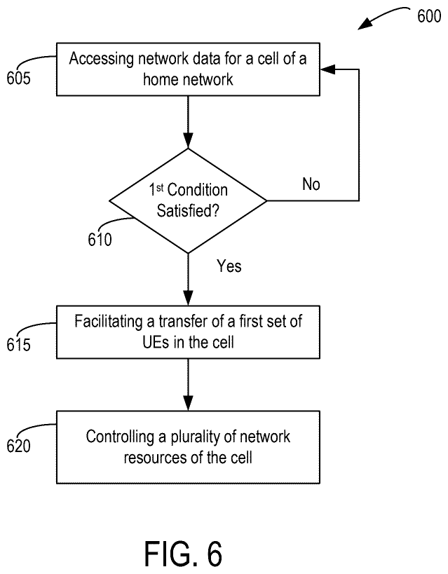

Returning to FIG. 6, the server 300 may control a plurality of network resources for the corresponding cell site(s) of the home network (at block 620). In some configurations, the server 300 may control the network resources for the corresponding cell site(s) responsive to determining that the shutdown condition is satisfied, facilitating the transfer of the UE(s) 110 of the corresponding cell site(s), or a combination thereof. Accordingly, in some instances, after determining that the shutdown condition is satisfied (e.g., Yes at block 610), the server may execute a shutdown event. As described herein, the shutdown event may include a reduction in network resources at one or more of the corresponding cell site(s). In some instances, the shutdown event includes transferring the UE(s) 110 of the corresponding cell site(s) prior to the reduction in network resources. In some examples, the shutdown event may include a complete shutdown of a cell site (e.g., ceasing operation of all network resources for a cell site). Alternatively, the shutdown event may include a partial shutdown of a cell site (e.g., ceasing or reducing operation of a subset of the network resources for a cell site). As one example, with reference to FIG. 4, the shutdown event may include ceasing operation of the second wireless access point 115B, the second RAN 130B, the second 5GC 140B, other component(s) included in the second provider network 505B, or a combination thereof. Accordingly, in some configurations, the server 300 may control the network resources for the corresponding cell site(s) of the home network by shutting down (or otherwise ceasing operation of) one or more network resources of the corresponding cell sites (e.g., such that operation of at least a subset of network resources for the cell are deactivated).

In some configurations, the server 300 may monitor the network data 335 while the UE(s) 110 operate on the partner network. For example, the server 300 may monitor the home network of the UE(s) 110, the UE(s) 110 operating on the partner network, or a combination thereof. For instance, the server 300 may monitor the network data 135 while the set of UE(s) 110 operate on the partner network. In some instances, the server 300 may monitor the network data 135 by accessing (or otherwise retrieving) the network data 135 (e.g., as described herein with respect to block 605 of FIG. 6). The server 300 may determine, based on the network data 335, whether a second condition of the roaming model 350 is satisfied. In some instances, the second condition of the roaming model 350 may be one or more reactivation conditions triggering a reactivation event. As described herein, a reactivation event may include (re) activating (or otherwise turning on) one or more network resources or components of the telecommunication network 100 (or cell site(s) thereof), such as, e.g., the one or more network resources or components shutdown as part of a shutdown event (e.g., at block 620 of FIG. 6), transferring one or more UEs 110 roaming on a partner network back to a home network (e.g., the one or more UEs 110 transferred to the partner network at block 615 of FIG. 6), or a combination thereof.

In some configurations, the reactivation condition may include (or otherwise define) a parameter and a threshold value for that parameter such that when a value of the parameter satisfies the threshold value (e.g., is greater than, less then, equal to, etc.) the reactivation condition is satisfied, and, thus, triggering the reactivation event. In some configurations, the reactivation condition may include multiple parameters and corresponding thresholds. Alternatively, or in addition, in some configurations, the reactivation condition may be cell site dependent such that different cell sites of the telecommunications network 100 may be associated with different conditions. For example, a first reactivation condition for a first cell site may be different than a second reactivation condition for a second cell site.

As one example, in some configurations, the reactivation condition may be a traffic load condition. A traffic load condition may include a network parameter that is related to traffic load (e.g., indicates a traffic load of a cell site). For example, the reactivation condition may include a number of active UEs 110 of a cell site (e.g., a number of the UEs 110 actively using a particular cell site) and a threshold number of active UEs 110 of a cell site. Following this example, when the number of active UEs 110 of a cell site exceed (e.g., is greater than or is great than or equal to) a threshold number of active UEs 110, the reactivation condition may be satisfied.

Alternatively, or in addition, in some configurations, the reactivation condition may be a temporal condition. A temporal condition may define a specific time schedule. For instance, the temporal condition may include, e.g., a time, a time range, a day of the week, a holiday, etc.). The temporal condition may be satisfied when a present (or temporally current) time or day condition matches the temporal condition. As one example, when the temporal condition includes a time range of 12:00 AM-2:00 AM and the present time is within the time range (e.g., is 1:00 AM), the temporal condition may be satisfied. As another example, the temporal condition may include a time range of 12:00 AM-2:00 AM and a day of the week of Monday. Following this example, the temporal condition may be satisfied when a present time is 1:00 AM and a present day of the week is Monday.

As noted herein, in some configurations, the reactivation condition may include multiple parameters and corresponding thresholds (e.g., multiple conditions). For instance, in some configurations, the reactivation condition may include a temporal condition and a traffic load condition. In such configurations, the reactivation condition may be satisfied when either the temporal condition or the traffic load condition is met. Alternatively, or in addition, in some configurations the reactivation condition may be satisfied when both the temporal condition and the traffic load condition is met.

In some configurations, the server 300 may determine whether the reactivation condition of the roaming model 350 is satisfied based on the network data 335 (e.g., as accessed at block 605). For instance, the server 300 may identify the relevant portion(s) of the network data 335 and compare those relevant portion(s) to a corresponding threshold (or thresholds) to determine whether the shutdown condition is satisfied.

For example, in some configurations, the reactivation condition may be a traffic load condition. In such instances, the server 300 may determine a current traffic load for a cell site of the telecommunications network 100 (e.g., a cell site that was previous shutdown, such as, e.g., via block 620 of FIG. 6). The server 300 may compare the current traffic load for the cell site to a corresponding traffic load threshold. When the current traffic load for the cell site is above the corresponding traffic load threshold, the server 300 may determine that the reactivation condition is satisfied. When the current traffic load for the cell site is below (or equal to) the corresponding traffic load threshold, the server 300 may determine that the reactivation condition is not satisfied.

Alternatively, or in addition, in some configurations, the reactivation condition may include a traffic load condition, a temporal condition, or a combination thereof. In such configurations, the server 300 may determine whether the reactivation condition is satisfied based on traffic load history information, e.g., as included in the network data 335, (as the traffic load condition), based on a specific time schedule (as the temporal condition), or a combination thereof. For example, the server 300 may determine whether the reactivation condition is satisfied based on traffic load data (or statistics) at or during a scheduled time or day. When the traffic load data for the scheduled time or day satisfy the traffic load threshold (e.g., is above the traffic load threshold), the server 300 may determine that the reactivation condition is satisfied. When the traffic load data for the scheduled time or day satisfy the traffic load threshold (e.g., is less than (or equal to) the traffic load threshold), the server 300 may determine that the reactivation condition is not satisfied.

In some examples, the reactivation condition may be based on a near-future cell load (e.g., be a near-future cell load condition). For instance, in some configurations, the server 300 may utilize an artificial intelligence or machine learning model (e.g., such as the traffic load prediction model described herein) to generate a prediction with respect to a near-future cell load. As one example, the server 300 may predict, using the traffic load prediction model, that a traffic load will be below a threshold for a time period or duration (e.g., the next hour) and, based on that prediction, move the UE(s) to a partner network and shutdown the corresponding cell site. In some instances, following this example, the server 300 may determine (or predict) that the reactivation condition is (or will be) satisfied after the time period or duration lapses (e.g., after an hour of time passes).

In some configurations, responsive to the second condition of the roaming model 350 being satisfied, the server 300 may control the plurality of network resources (e.g., the one or more network resources controlled at block 620 of FIG. 6) of the cell such that operation of the plurality of network resources of the cell are activated. Alternatively, or in addition, in some configurations, the server 300 may also, responsive to the second condition of the roaming model 350 being satisfied, control (or otherwise facilitate) a second transfer of the set of UE(s) 110 from the provider network to the home network (e.g., the one or more UE(s) 110 transferred at block 615 of FIG. 6). In some configurations, the server 300 may control the second transfer of the set of UE(s) 110 as described herein with respect to block 615 of FIG. 6.

In some configurations, the technology disclosed herein may implement game theory (e.g., one or more game theoretic models). For example, in some configurations, the server 300 may determine whether to execute (or otherwise trigger) a shutdown event using a game theoretic approach (e.g., as a shutdown condition). In such configurations, each provider (or operator) may be considered players. For an example having two players, the four states of the gam may include: (1) Op1-Op2: ON-ON; (2) Op1-Op2: ON-OFF; (3) Op1-Op2: OFF-ON; and (4) Op1-Op2: OFF-OFF. The server 300 may determine, for each state, a gain/loss for each player (i.e., provider or operator), solve the game, and identify a Nash-Equilibrium. For instance, the server 300 may consider, for each one of the two operators: income for handing an active UE in home network; income for handling of a roamed active UE for the roaming partner; cost of keeping the cell on; FCC penalty for the operator with cell off if the other one is on; FCC penalty if both the operators turn their cells off. In such configurations, each operator selects the strategy: cell on or off to achieve the Nash equilibrium.

Other examples and uses of the disclosed technology will be apparent to those having ordinary skill in the art upon consideration of the specification and practice of the technology disclosed herein. The specification and examples given should be considered exemplary only, and it is contemplated that the appended claims will cover any other such embodiments or modifications as fall within the true scope of the technology disclosed herein.

The Abstract accompanying this specification is provided to enable the United States Patent and Trademark Office and the public generally to determine quickly from a cursory inspection the nature and gist of the technical disclosure and in no way intended for defining, determining, or limiting the present technology disclosed herein or any of its embodiments.

What is claimed is:

1. A system to dynamically transfer user equipment (UE) between telecommunication networks using a roaming model, the system comprising:
a processing system comprising one or more electronic processors, the processing system configured to:
access first network data for a cell of a home network servicing a set of UE;
determine, based on the first network data, whether a first condition of the roaming model is satisfied;
responsive to the first condition being satisfied:
facilitate a first transfer of the set of UE from the home network to a partner network such that the partner network provides telecommunication services for the set of UE; and
control a plurality of network resources for the cell of the home network such that operation of a subset of the plurality of network resources for the cell are deactivated.

2. The system of claim 1, wherein the processing system is configured to:
responsive to a reactivation of the subset of the plurality of network resources, facilitate a second transfer of the set of UE from the partner network to the home network such that the home network provides telecommunication services for the set of UE.

3. The system of claim 2, wherein the processing system is configured to:
detect when a second condition of the roaming model is satisfied; and
responsive to the second condition of the roaming model being satisfied, control the reactivation of the subset of the plurality of network resources.

4. The system of claim 1, wherein the home network and the partner network are provider land mobile networks (PLMNs).

5. The system of claim 4, wherein the processing system is configured to facilitate the first transfer by controlling an inter-PLMN handover between the home network and the partner network.

6. The system of claim 4, wherein the processing system is configured to facilitate the first transfer by controlling an inter-PLMN conditional handover between the home network and the partner network.

7. The system of claim 1, wherein the processing system is configured to facilitate the first transfer by controlling an inter-PLMN handover using an N26 interface.

8. The system of claim 1, wherein the processing system is configured to facilitate the first transfer by controlling an inter-PLMN handover using an N14 interface.

9. The system of claim 1, wherein the subset of the plurality of network resources for the cell includes at least one of a radio unit (RU), a centralized unit (CU), or a distributed unit (DU) included in a radio access network (RAN) of the cell.

10. The system of claim 1, wherein the first condition includes a traffic load condition for the cell, and wherein the processing system is configured to determine that the first condition of the roaming model is satisfied when a traffic load parameter of the cell is below a traffic load threshold.

11. The system of claim 1, wherein the first condition includes a temporal condition and a traffic load condition for the cell, and wherein the processing system is configured to determine that the first condition of the roaming model is satisfied when a traffic load parameter occurring within the temporal condition is below a traffic load threshold.

12. A method to dynamically transfer user equipment (UE) between telecommunication networks using a roaming model, the method comprising:
accessing, with a processing system including one or more electronic processors, first network data for a cell of a home network providing telecommunication services for a set of UE;
determining, with the processing system, based on the first network data, that a first condition of the roaming model is satisfied;
controlling, with the processing system, a first transfer of the set of UE from the home network to a partner network;
controlling, with the processing system, a plurality of network resources of the cell such that operation of the plurality of network resources of the cell are deactivated; and
responsive to a reactivation of the subset of the plurality of network resources, controlling, with the processing system, a second transfer of the set of UE from the provider network to the home network.

13. The method of claim 12, further comprising
monitoring, with the processing system, the first network data while the set of UE operate on the partner network;
determining, with the processing system, based on the first network data, that a second condition of the roaming model is satisfied; and
controlling, with the processing system, the plurality of network resources of the cell such that operation of the plurality of network resources of the cell are activated.

14. The method of claim 12, wherein facilitating the first transfer includes controlling an inter-PLMN handover between the home network and the partner network.

15. The method of claim 12, wherein facilitating the first transfer includes facilitating the first transfer using an access traffic steering, switching, and splitting (ATSSS) function.

16. The method of claim 12, wherein determining, with the processing system, that a first condition of the roaming model is satisfied includes determining, with the processing system, that a number of active UEs of the set of UEs on the cell is below a threshold.

17. A non-transitory computer-readable medium storing instructions that, when executed by one or more electronic processors of a processing system in a telecommunications network, cause the processing system to perform operations comprising:
accessing first network data for a cell of a home network providing telecommunication services for a set of UE;
determining, based on the first network data, that a first condition of the roaming model is satisfied;
controlling a first transfer of the set of UE from the home network to a partner network;
controlling a plurality of network resources of the cell such that operation of the plurality of network resources of the cell are deactivated;
monitoring the first network data while the set of UE operate on the partner network;
determining, based on the first network data, that a second condition of the roaming model is satisfied;
controlling the plurality of network resources of the cell such that operation of the plurality of network resources of the cell are activated; and
controlling a second transfer of the set of UE from the provider network to the home network.

18. The non-transitory computer-readable medium of claim 17, wherein determining, based on the first network data, that the first condition of the roaming model is satisfied includes determining, for the cell, that a traffic load parameter occurring within the temporal condition is below a traffic load threshold.

19. The non-transitory computer-readable medium of claim 17,
wherein determining, based on the first network data, that the first condition of the roaming model is satisfied includes determining, for the cell, that a traffic load parameter is below a traffic load threshold, and
wherein determining, based on the first network data, that the second condition of the roaming model is satisfied includes determining, for the cell, that the traffic load parameter is above the traffic load threshold.

20. The non-transitory computer-readable medium of claim 17, wherein determining, based on the first network data, that the first condition of the roaming model is satisfied includes predicting, with a machine learning model, based on the first network data, that the first condition of the roaming model will be satisfied during a time period.
